(19) United States
(12) Patent Application Publication
(10) Pub. No.: US 2006/0045708 A1
(43) Pub. Date: Mar. 2, 2006

(54) Patient lift with three-point vertical stance

(76) Inventors: Colin C. Bain, Longmont, CO (US); David Genske, Westminster, CO (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/911,923

(22) Filed: Aug. 5, 2004

(51) Int. Cl. B66F 9/18

(52) U.S. Cl. 414/620

(57) ABSTRACT

A portable patient lift comprises a base and a mast that is foldable relative to the base to expose a lower end of the mast. The lower end of the mast protrudes rearward to define one point of a three-point stance when the mast is folded and the lift is set on end.

### BACKGROUND OF INVENTION

This invention relates in general to hoisting equipment and more particularly, to a portable lifting device for lifting and moving incapacitated persons or patients.

Devices for lifting and moving patients are well known. Such devices typically include a base, a mast extending upwardly from the base, and a boom extending forward from the mast. The boom generally supports a cradle from which the patient can be suspended. Rollers or wheels depending from the base enable the device and the patient to be moved or manipulated.

Portable lift devices may be compactly folded for transportation and set on end for storage. Conventional lifts, when folded and set on end for storage, set on a three or four-point stance. However, the stance points are relatively close together and thus provide limited stability.

What is needed is a lift that provides greater stability when folded and set on end for storage.

### SUMMARY OF INVENTION

The present invention is directed toward a portable patient lift that meets the foregoing needs. The portable patient lift comprises a base and a mast that is foldable relative to the base to expose a lower end of the mast. The lower end of the mast protrudes rearward to define one point of a three-point stance when the mast is folded and the lift is set on end.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a front perspective view of a lift according to a preferred embodiment of the invention.

FIG. 2 is a rear perspective view of the lift shown in FIG. 1.

FIG. 3 is an enlarged partially exploded partial front perspective view of the lift shown in FIG. 1.

FIG. 4 is an elevational view of the top of the lift shown in FIGS. 1 and 2 compactly folded and set on end for storage.

FIG. 5 is a side elevational view of the lift shown in FIG. 4.

### DETAILED DESCRIPTION

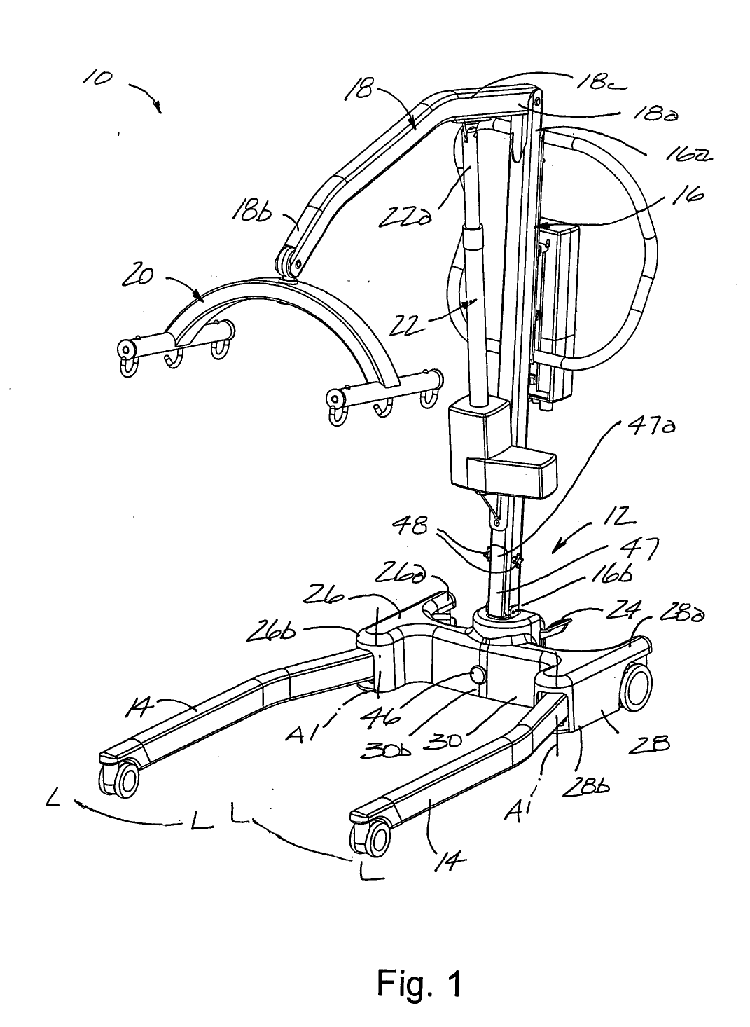

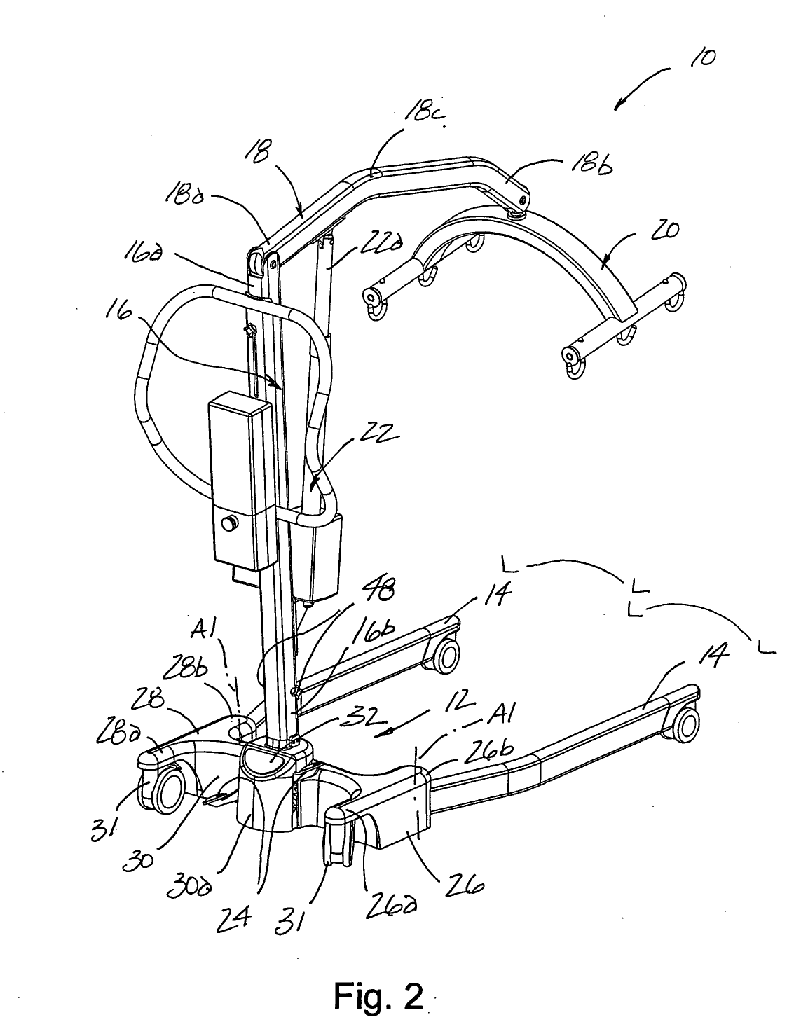

Referring now to the drawings, there is illustrated in FIGS. 1 and 2 a portable patient lift, indicated generally at 10. The lift 10 preferably includes a base 12. A pair of displaceable support legs 14 extends horizontally from the base 12. A mast 16 extends vertically from the base 12. A boom 18 extends from an upper end 16a of the mast 16. The mast 16 is preferably not telescopic, but rather a single piece. The boom 18 is preferably pivotally connected at one end 18a to the mast 16 and has a cradle 20 at its other end 18b for lifting patients. An actuator 22 is mounted part way up the height of the mast 16 and is connected at its far end 22a to an intermediate portion 18c of the boom 18 so that actuation of the actuator 22 pivots the boom 18 relative to the mast 16.

The illustrated base 12 is generally H-shaped, having right and left sides 26, 28 oriented in a forward/rearward direction, and having a central connecting portion 30 extending laterally between the sides 26, 28. Each side 26, 28 has a rearward end 26a, 28a to which a caster wheel 31 is mounted for rotation. A forward end 26b, 28b of each side 26, 28 may provide a mounting point for a corresponding one of the legs 14, wherein the legs 14 may be rotatable on a vertical axis A1 for opening and closing the legs 14 relative to each other. The central connection portion 30 has a rear end 30a (shown in FIG. 2) facing the operator with an integrated foot push pad 32. The push pad 32 preferably has an angled face, which is suitable for the operator to apply foot pressure when moving or manipulating the lift 10. Force from the operator's foot gives the operator extra leverage and/or control when moving or manipulating the lift 10. With the push pad 32 integrated into the base 12, and having a high-friction surface, the operator's foot will be less likely to slip off the base 12 than if no foot push pad were provided.

During operation of the lift (i.e., when lifting and moving patients), the legs 14 can be moved (e.g., along lines L-L) to accommodate the operating needs of the lift 10. Movement of the legs 14 is accomplished by operation of a foot pedal 24. The legs 14 preferably operate in unison so that when one leg 14 opens or closes, the other leg 14 opens or closes as well. The foot pedal 24 may operate a mechanical controller (not shown), which is adapted to hold the legs 14 in place and thus prevent the legs 14 from inadvertently closing or otherwise moving when a patient is suspended by the lift 10. The foot pedal 24 may be actuated by foot action of the lift operator. The legs 14 preferably operate in a first range of motion during a lifting and moving operation of the lift 10, and a second range of motion for compactly folding the lift 10. The legs 14 are preferably adapted to be disengaged from the mechanical controller by pulling a hand-operated, spring-loaded control knob 46 on a front end 30b of the central connection portion 30 of the base 12. The legs 14 may be re-engaged with the mechanical controller to hold the legs 14 in the folded position for secure placement of the legs 14 when transporting and storing the lift 10. Alternatively, the legs 14 may remain disengaged from the mechanical controller and may be otherwise retrained, such as by tethers, when transporting and storing the lift 10. The control knob 46 is preferably hand operated, as are the legs 14 when disengaged from the mechanical controller. In this way, no tools are required to fold the lift 10. It is also preferable that the major parts of the lift 10 be moved or folded without tools, including the legs 14, the mast 16 and the boom 18.

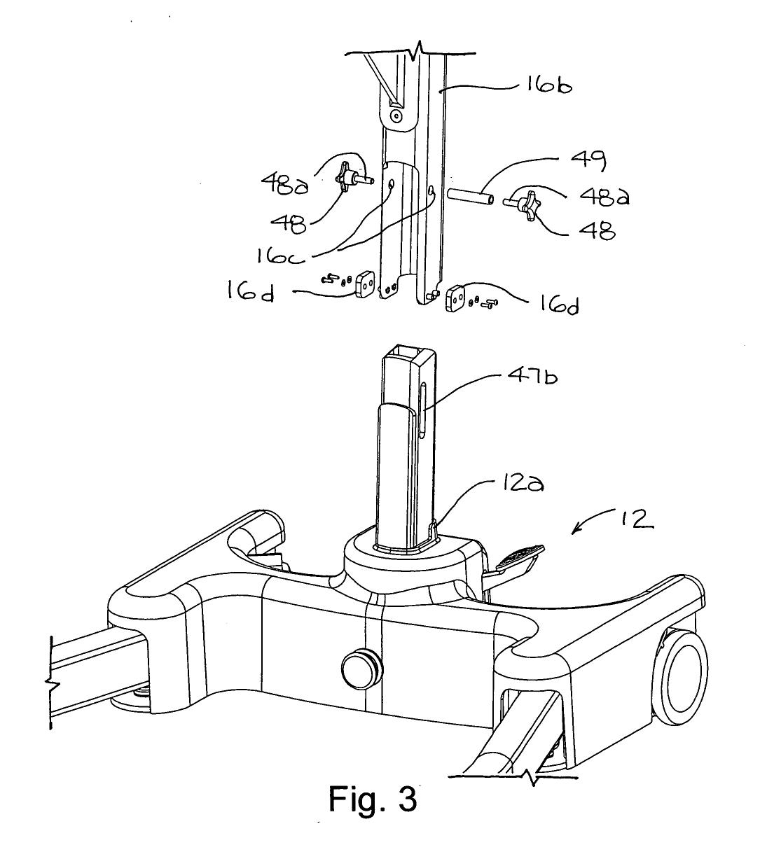

In accordance with a preferred embodiment of the invention, the mast 16 is attached to the lift base 12 by means of a short vertical mast support post 47 that is fixed with respect to the base 12. The mast 16 may be pivotally mounted at a top end 47a (shown in FIG. 1) of the support post 47. The mast 16 is preferably held in a position with respect to the support post 47, such as by one or more hand-operated control knobs 48. As shown in FIG. 3, a threaded portion 48a may extend from each hand-operated control knobs 48. Each threaded portion 48a may cooperate with a binder 49. The support post 47 may have one or more vertical slots 47b. One of more holes 16c in the lower end 16b of the mast 16 may align with the slots 47b in the support post 47. The binder 49 may be positioned within the lower end 16b of the mast 16 to permit the threaded portions 48a to pass though the holes 16c and slots 47b in the support post 47. In this way, the threaded portions 48a can be tightened into the binder 49 by the hand-operated control knob 48. According to a preferred embodiment of the invention, a foot 16d at the lower end 16b of the mast 16 may engage a raised portion 12a of the base 12 to prevent the mast 16 from pivoting further forward beyond vertical. Upon loosening the threaded portions 48a relative to the binder 49, the mast 16 can be lifted (i.e., as the threaded portions 48a travel in the slots 47a in the support post 47) until the foot 16e clears the raised portion 12a. At this point, the mast 16 may be pivoted forward with respect to the support post 47 to permit the mast 16 to be folded without requiring tools for disengagement of the mast 16.

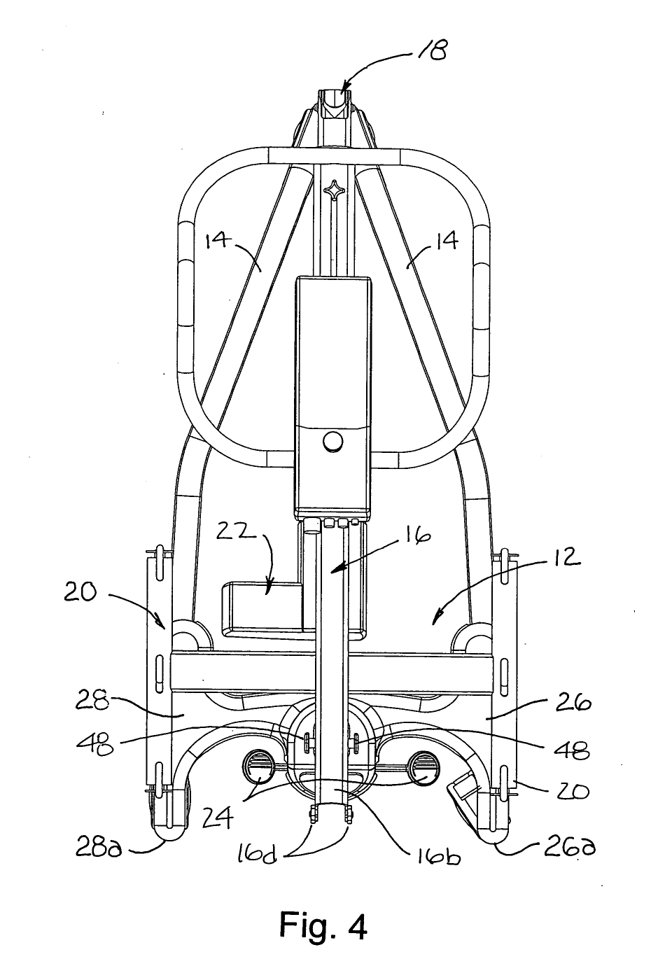

When not in use, the lift 10 may be folded for easy transporting and storing. To fold the lift 10, the legs 14 are first collapsed together, as shown in FIG. 4. Then, the boom 18 is pivoted down so that it is substantially parallel with the mast 16. Finally, the mast 16, with the downward pivoted boom 18, is pivoted down toward or onto the base 12 to assume a position nearly parallel with the legs 14 and the ground or other surface supporting the lift 10.

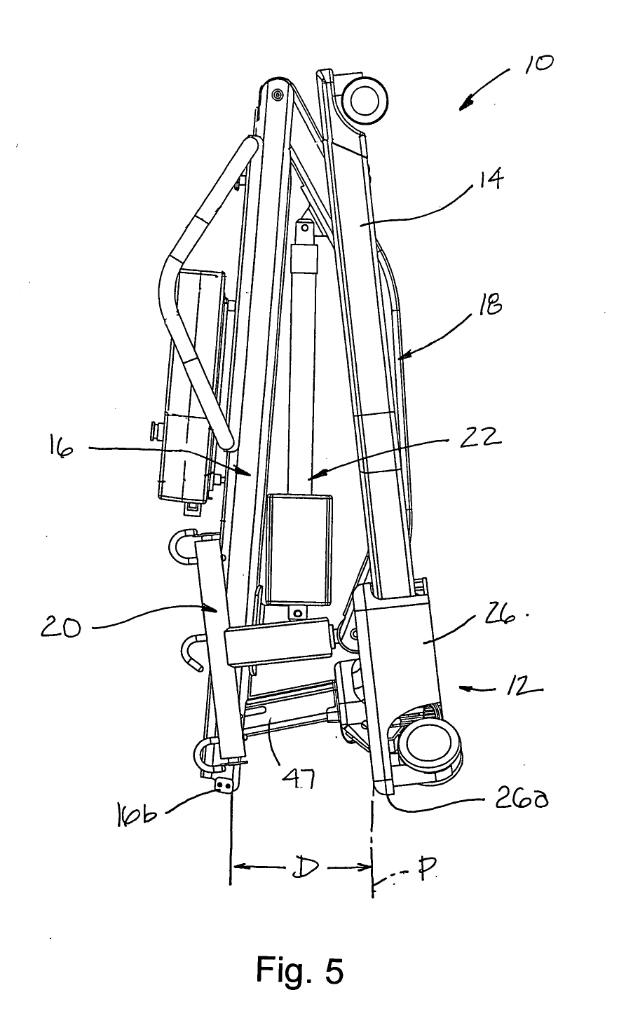

When the lift 10 is folded for transporting or storing, a lower end 16b of the mast 16, having been pivoted relative to the support post 47, preferably protrudes rearward with respect to the lift 10. In this way, when the folded lift 10 is set on end, the lift 10 may rest in a three-point vertical stance, as shown in FIGS. 4 and 5. In this stance, the lift 10 may be entirely supported by the rearward ends 26a, 28a of the right and left sides 26, 28 of the base 12 and by the exposed lower end 16b of the pivoted mast 16. The length of the support post 47, which is most preferably in a range of about 3 inches to about 12 inches, defines the distance D between the exposed lower end 16b of the mast 16 and a plane P connecting the two rearward ends 26a, 28a of the sides 26, 28 of the base 12. The advantage of this lift 10 over conventional lifts is that one of the points of the three-point stance is separated far enough away from the other points (the rearward ends 26a, 28a of each side 26, 28 of the base 12) for good stability.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A portable patient lift comprising:
a base; and
a mast that is foldable relative to the base to expose a lower end of the mast, wherein the lower end of the mast protrudes rearward to define one point of a three-point stance when the mast is folded and the lift is set on end.

2. The lift of claim 1, further comprising a vertical mast support post fixed with respect to the base, the mast being mounted for pivotal movable at a top end of the support post.

3. The lift of claim 2 wherein the base has sides each with a rearward end and the support post has a length that defines a distance between the lower end of the mast and a plane connecting the rearward ends of the sides of the base.

4. The lift of claim 3 wherein the support post has a length that is in a range of about 3 inches to about 12 inches.

5. The lift of claim 1, further comprising a connection for preventing the mast from pivoting with respect to the base.

6. The lift of claim 5 wherein the connection includes a hand-operated control knob.

7. The lift of claim 1 wherein the base has two sides, each with a rearward end and the other two points of the three-point stance are defined by the rearward ends of the two sides of the base.

8. The lift of claim 7 wherein the one point is separated from the two other points a sufficient distance to provide stability for the lift when set on end.

9. A portable patient lift comprising:
a base;
a mast mounted with respect to the base, the mast being adapted to pivot with respect to the base so that a lower end of the mast protrudes rearward with respect to the base, and wherein the lift is adapted to be folded and set on end to rest in a three-point vertical stance.

10. The lift of claim 9, further comprising a vertical mast support post fixed with respect to the base, the mast being pivotally mounted at a top end of the support post.

11. The lift of claim 10, further comprising a connection for preventing the mast from pivoting with respect to the support post.

12. The lift of claim 11 wherein the connection is a hand-operated control knob.

13. The lift of claim 12 wherein a threaded portion extending from the hand-operated control knob cooperates with a binder and the support post has one or more vertical slots that align with one of more holes in the lower end of the mast, the binder being positioned within the lower end of the mast, the threaded portion being adapted to pass though the holes and slots and be tightened by the hand-operated control knob to prevent the mast from pivoting.

14. The lift of claim 9 wherein the base has sides each with a rearward end and the support post having a length that defines a distance between the lower end of the mast and a plane connecting the rearward ends of the sides of the base.

15. The lift of claim 14 wherein the support post has a length this is in a range of about 3 inches to about 12 inches.

16. The lift of claim 14 wherein one point of the three-point stance is defined by the lower end of the mast and the other two points of the three-point stance are defined by the rearward ends of the base, the one point being separated from the two points a sufficient distance to provide stability for the lift when set on end.

17. A portable patient lift comprising:
a base having two sides each with a rearward end;
two legs extending forward from the base;
a mast pivotally mounted at the base, the mast having a lower end;
a boom extending forward from the mast, the lift being foldable by closing the legs together, pivoting the boom toward the mast, and pivoting the mast toward the base, wherein the mast is adapted to pivot with respect to the base so that the lower end of the mast protrudes rearward with respect to the base, and wherein the lift is adapted to be set on end to rest in a three-point vertical stance defined by the lower end of the mast and a rearward end of each of the sides of the base.

18. The lift of claim 17, further comprising a vertical mast support post fixed with respect to the base, the support post having a top end, the mast being pivotally mounted at a top end of the support post.

19. The lift of claim 18, further comprising a connection for preventing the mast from pivoting with respect to the support post.

20. The lift of claim 19 wherein the connection is a hand-operated control knob.

21. The lift of claim 18 wherein the support post has a length that defines a distance between the lower end of the mast and a plane connecting the rearward ends of the sides of the base.

22. The lift of claim 17 wherein the point of the three-point stance defined by the lower end of the mast is separated from the two points defined by the rearward ends of the base a sufficient distance to provide stability for the lift when set on end.
